(19) United States
(12) Patent Application Publication
(10) Pub. No.: US 2004/0181663 A1
(43) Pub. Date: Sep. 16, 2004

(54) Forced encryption for wireless local area networks

(76) Inventors: Sami Pienimaki, Tampere (FI); Jari Korpiharju, Espoo (FI); Niklas Lyback, Espoo (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/679,486

(22) Filed: Oct. 7, 2003

Related U.S. Application Data
(60) Provisional application No. 60/453,953, filed on Mar. 13, 2003.

(51) Int. Cl. H04L 9/00

(52) U.S. Cl. 713/155; 713/201

(57) ABSTRACT

A method of enforcing encryption on a public wireless local area network having at least one access point for the wireless connection of user terminals, an authentication, authorization and accounting system, and at least one access control point for controlling access to the network, for initiating an authentication, authorization and accounting procedure for an accessing terminal, and for providing an Internet access gateway functionality. The method includes authenticating a user terminal to the authentication, authorization and accounting system, requesting access to the Internet by the user terminal, and enforcing applications corresponding to the Internet access request of the user terminal to switch their traffic to an encrypting security service port.

The present application claims the benefit of priority of provisional application Serial No. 60/453,953, filed Mar. 13, 2003, the contents of which are incorporated herein by reference.

### BACKGROUND OF THE INVENTION

The present invention relates to a method of enforcing encryption on a public wireless local area network as well as to a related system and network element.

### Related Art

Currently, in practice all traffic in public access zones of wireless local area networks (WLAN) is not encrypted, with the exception of users of virtual private network (VPN) applications. However, in unlicensed public wireless local area networks (WLAN), special attention has to be paid to security issues such as to protect the end users privacy. So far, presently implemented wireless LAN installations comprise security features to offer an encryption for the open air interface. Though, these are not considered to be feasible for public installations due to a lack of being scaleable. Further, no feasible key distribution mechanisms for the encryption are known yet. Moreover, several vulnerabilities have been found so that ready-made tools may be found from the Internet to hack these systems.

Thus, standards are recently under development such as in “IEEE 802.11 task group i” which are about to develop solutions for these problems. Though, the implementation of these solutions will require new software and most likely also new hardware to be installed at the network, and, most importantly, new software and new hardware to be installed at the end users side.

### SUMMARY OF THE INVENTION

Therefore, it is an object of the present invention to overcome the above shortcomings of the prior art. The present invention is a method of enforcing encryption on a public wireless local area network, the public wireless local area network comprising: at least one access point for the wireless connection of corresponding user terminals; an authentication, authorization and accounting system; and at least one access control point for controlling access to the network, for initiating an authentication, authorization and accounting procedure for an accessing terminal, and for providing an Internet access gateway functionality; the method comprising: authenticating a user terminal to the authentication, authorization and accounting system upon arrival in a service area of the public wireless local area network; requesting access to the Internet by the user terminal; and enforcing applications corresponding to the Internet access request of the user terminal to switch their traffic to an encrypting security service port.

In addition, the present invention is a system for enforcing encryption on a public wireless local area network, comprising at least one user terminal, and a public wireless local area network, which comprises: at least one access point for the wireless connection of a user terminal; an authentication, authorization and accounting sub-system; and at least one access control point for controlling access to the network, for initiating an authentication, authorization and accounting procedure for a user terminal at the authentication, authorization and accounting sub-system upon its arrival in a service area of the public wireless local area network, for providing an Internet access gateway functionality, and for enforcing applications corresponding to an Internet access request of the user terminal to switch their traffic to an encrypting security service port.

Furthermore, the present invention is also an access control point network element for enforcing encryption on a public wireless local area network, comprising: means for controlling access to the network; means for initiating an authentication, authorization and accounting procedure for a user terminal at an authentication, authorization and accounting sub-system of the public wireless local area network upon arrival of the user terminal in a service area of the public wireless local area network; means for providing an Internet access gateway functionality; and means for enforcing applications corresponding to an Internet access request of the user terminal to switch their traffic to an encrypting security service port.

In a preferred embodiment of the present invention, the access control point retrieves information from RADIUS messages which user terminals do not use a 802.11i encryption, and directs the traffic encryption enforcement only to the such identified user terminals.

Preferably, the encrypting security service is the secure sockets layer (SSL) or the transport layer security (TLS).

Accordingly, it is an advantage of the present invention that it is suitable for virtually all wireless local area network terminals without requiring any software installations at the terminal side. In addition, no changes on a used operating system or a browser type are necessary. Further, the present invention is transparent for most of the network elements thus requiring only minor changes in the network.

Hence, a major security enhancement for public wireless local area network access zones is provided by the present invention. That is, contrary to the prior art, the present invention also allows end users without a virtual private network to use most of their applications securely. On the other hand, the present invention is transparent for users of a virtual private network. In general, the present invention is easy to implement and to deploy, and it does not require any changes at the terminals of any end user, since there already exists a wide support for the secure sockets layer and for the transport layer security, while most of the used applications such as browsing and email are addressed by the present invention.

### BRIEF DESCRIPTION OF THE DRAWINGS

Further details, features and advantages of the present invention will become more readily apparent from the following detailed description of the preferred embodiments which is to be taken in conjunction with the appended drawing, in which:

FIG. 1 shows a wireless local area network architecture underlying the present invention.

### DETAILED DESCRIPTION OF THE PREFERRED EMBODIMENTS

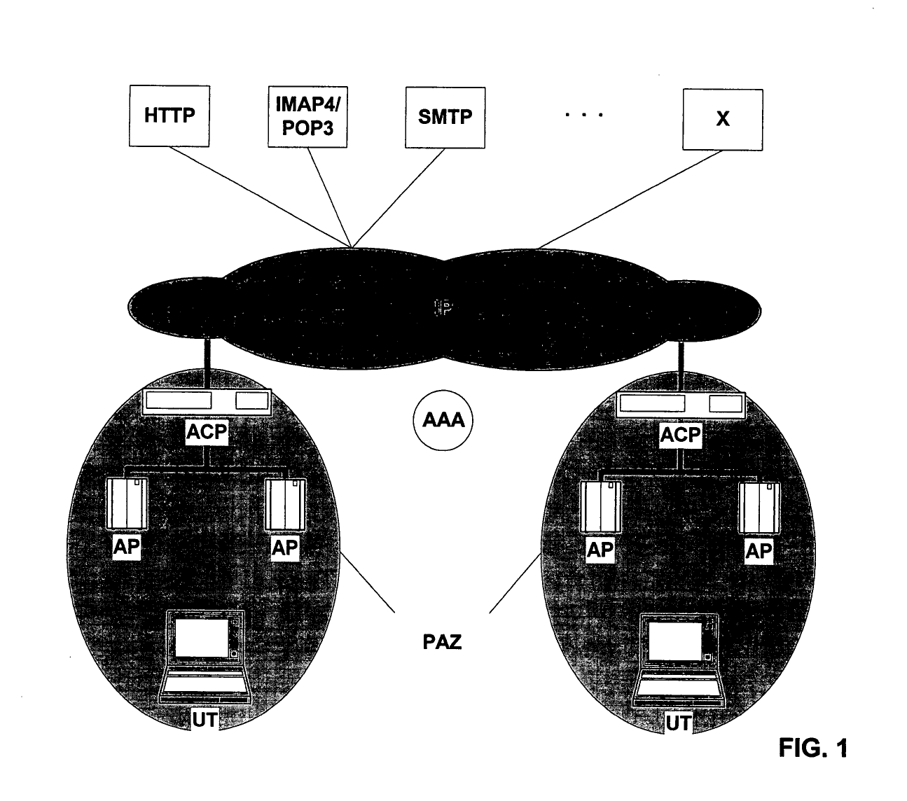

As shown in FIG. 1, a public wireless local area network underlying the present invention comprises the following physical and logical elements: wireless local area network (WLAN) terminals UT used by end users and access points AP, access control points ACP and authentication, authorization and accounting (AAA) systems AAA operated by a network operator. The terminals UT are used to access the wireless local area network via a radio interface. The counterpart in the network regarding this interface is the access point AP. An access control point ACP controls the access to the network and initiates the authentication, authorization and accounting (AAA) for the terminal UT in question. The authentication, authorization and accounting system AAA is a back end system for providing corresponding functions. All or some of the above network elements may reside in a same physical network element.

According to the preferred embodiment of the present invention, if an end user arrives to a public wireless local area network service area (a public access zone PAZ), she/he authenticates herself/himself towards the authentication, authorization and accounting system AAA. After the authentication, the end user has access to the Internet IP, but her/his traffic over the air-interface is not necessarily encrypted.

Here, when the end user tries to access the Internet IP, the access control point ACP forces applications X to switch the traffic to an encrypted port such as according to the secure sockets layer SSL (as developed by Netscape) or according to the transport layer security TLS (see RFC2246 of the Internet Engineering Task Force), before it allows any traffic to go through. This is possible even if the initial request for the application in question is sent un-encrypted. Examples of applications that can be forced to use the secure sockets layer SSL or the transport layer security TLS encryption include application layer protocols running on top of the TCP/IP (transport control protocol, Internet protocol) and UDP/IP (user datagram protocol), respectively, such as the hypertext transfer protocol HTTP for browsing the Internet, the Internet message access protocol 4 IMAP4 as well as the post office protocol 3 POP3 for incoming mail, and the simple mail transfer protocol SMTP for outgoing mail.

The above described enforcement to switch the traffic to an encrypted port can also be configured to only take place for users without an 802.11i encryption in the WLAN interface. In this case, the access control point ACP retrieves this knowledge from RADIUS (Remote Authentication Dial-In User Service) messages.

Thus, what is described above is a method as well as related system and network element of enforcing encryption on a public wireless local area network, the public wireless local area network comprising: at least one access point for the wireless connection of corresponding user terminals; an authentication, authorization and accounting system; and at least one access control point for controlling access to the network, for initiating an authentication, authorization and accounting procedure for an accessing terminal, and for providing an Internet access gateway functionality; the method comprising: authenticating a user terminal to the authentication, authorization and accounting system upon arrival in a service area of the public wireless local area network; requesting access to the Internet by the user terminal; and enforcing applications corresponding to the Internet access request of the user terminal to switch their traffic to an encrypting security service port.

While it is described above what is presently considered to be the preferred embodiments of the present invention, it is apparent to those who are skilled in the art that various changes and modifications may be made without departing from the spirit and scope of the present invention as defined in the appended claims.

What is claimed is:

1. A method of enforcing encryption on a public wireless local area network, the public wireless local area network comprising:
at least one access point for the wireless connection of corresponding user terminals;
an authentication, authorization and accounting system; and
at least one access control point for controlling access to the network, for initiating an authentication, authorization and accounting procedure for an accessing terminal, and for providing an Internet access gateway functionality; the method comprising:
authenticating a user terminal to the authentication, authorization and accounting system upon arrival in a service area of the public wireless local area network;
requesting access to the Internet by the user terminal; and
enforcing applications corresponding to the Internet access request of the user terminal to switch their traffic to an encrypting security service port.

2. The method according to claim 1, wherein the encrypting security service is the secure sockets layer or the transport layer security.

3. The method according to claim 1, wherein the enforcement is performed by a responsible access control point.

4. The method according to claim 1, wherein the enforcement is performed by a responsible wireless local area network gateway.

5. The method according to claim 1, further comprising:
retrieving information by the access control point from RADIUS messages which user terminals do not use a 802.11i encryption; and
directing the traffic encryption enforcement only to the such identified user terminals.

6. The method according to claim 1, wherein the enforced applications are selected from a group comprising the hypertext transfer protocol for browsing the Internet, the Internet message access protocol 4, the post office protocol 3, and the simple mail transfer protocol.

7. A system for enforcing encryption on a public wireless local area network, comprising at least one user terminal, and a public wireless local area network, which comprises:
at least one access point for the wireless connection of a user terminal;
an authentication, authorization and accounting sub-system; and
at least one access control point for controlling access to the network, for initiating an authentication, authorization and accounting procedure for a user terminal at the authentication, authorization and accounting sub-system upon its arrival in a service area of the public wireless local area network, for providing an Internet access gateway functionality, and for enforcing applications corresponding to an Internet access request of the user terminal to switch their traffic to an encrypting security service port.

8. The system according to claim 7, wherein the encrypting security service is the secure sockets layer or the transport layer security.

9. The system according to claim 7, wherein the access control point retrieves information from RADIUS messages which user terminals do not use a 802.11i encryption and directs the traffic encryption enforcement only to the such identified user terminals.

10. An access control point network element for enforcing encryption on a public wireless local area network, comprising:
means for controlling access to the network;
means for initiating an authentication, authorization and accounting procedure for a user terminal at an authentication, authorization and accounting sub-system of the public wireless local area network upon arrival of the user terminal in a service area of the public wireless local area network;
means for providing an Internet access gateway functionality; and
means for enforcing applications corresponding to an Internet access request of the user terminal to switch their traffic to an encrypting security service port.

11. The network element according to claim 10, wherein the encrypting security service is the secure sockets layer or the transport layer security.

12. The network element according to claim 10, further comprising:
means for retrieving information from RADIUS messages which user terminals do not use a 802.11i encryption; and
means for directing the traffic encryption enforcement only to the such identified user terminals.
